(19) United States
(12) Patent Application Publication
(10) Pub. No.: US 2016/0349039 A1
(43) Pub. Date: Dec. 1, 2016

(54) Runout Calibrator for Hydrodynamic Bearing Testing

(71) Applicant: Caterpillar Inc., Peoria, IL (US)

(72) Inventors: Richard G. Marsh, Edwards, IL (US); Rohit Arun Bhapkar, Peoria, IL (US); Marion Billingsley Grant, JR., Princeville, IL (US)

(73) Assignee: CATERPILLAR INC., Peoria, IL (US)

(21) Appl. No.: 14/722,314

(22) Filed: May 27, 2015

(51) Int. Cl. G01B 11/14; G01M 13/04

(52) U.S. Cl. CPC G01B 11/14; G01M 13/04

(57) ABSTRACT

A runout calibrator for use in measuring runout of a spindle of a machine tool using at least one hydrodynamic bearing includes a head assembly with a shaft adapted at a first end for mounting in a chuck of the machine tool and a head mounted to a second end of the shaft. The head has a reflective surface and at least one line of symmetry coincident with the centerline of the shaft. The runout calibrator also includes a sensor assembly with one or more optical sensors mounted orthogonal to each other for measuring a distance between each of the one or more sensors and the head.

### TECHNICAL FIELD

The present disclosure is generally directed to machine tools and more particularly to runout testing for spindles of machine tools using hydrodynamic bearings.

### BACKGROUND

Spindles used in machine tools, for example, lathes and drill presses often use either ball bearings or hydrostatic bearings for rotatably mounting the spindle. These bearings are active all the time and bearing runout, that is, movement off a center axis of the spindle, can be measured while the tool is rotated very slowly—well below operating speeds. It is common for runout in these tools to be measured using a metallic element mounted to the spindle and a capacitive sensor element put in close proximity to the spindle-mounted ceramic element. As the spindle is rotated, a change in capacitance is measured. The change in capacitance is translated to a runout measurement for the spindle. The distance between the spindle-mounted element and the sensor element must be quite small, on the order of 100 micrometers (μm). Such measurement instruments are commercially available from, for example, IBS Precision Engineering of Stuttgart, Germany.

Some precision grinding or machining applications, where very high tolerance parts are made, use hydrodynamic bearings for the spindle mount. Shafts or journals using hydrodynamic bearings, unlike ball bearings or hydrostatic bearings, are only centered after the shaft or journal has reached a minimum operating speed. When at rest, the shaft may droop several millimeters off center. However, while operating at speeds of tens of thousands of rpms up to even 100,000 rpms, the shaft may have a runout on the order of only a few microns. Because the capacitive sensors must be within about 100 μm of the spindle mounted element but the spindle with hydrodynamic bearings begins off center as much as several millimeters, the capacitive sensors would be damaged as the spindle spins up and reaches operating speed. Attempts to position the capacitive sensors after the spindle is operating at speed are risky because any contact between the spindle-mounted ceramic element and the capacitive sensor can destroy the sensor and damage the spindle. Such a placement process is further hampered by difficulty in maneuvering the capacitive sensor assembly and associated cabling inside the work area of the machine tool, which typically has covers and interlocks to prevent work chamber access when the spindle is operating. Therefore, these capacitive runout sensors cannot be used to map spindle runout for hydrodynamic bearings.

Another type of runout measurement tools are optical in basis. Such optical runout measurement tools use mirrors mounted on a shaft loaded in the chuck of the spindle. These sensors also cannot be operated at speed because the retro reflectors cannot compensate for the change in position as fast as is needed when the spindle is operating at speed.

Because of the difficulty in measuring runout in spindles using hydrodynamic bearings, machine tools so equipped are mostly just monitored for generating work product that is out of specification. This is both wasteful and time consuming and also foregoes early detection of bearing problems that can lead to costly equipment failures.

### SUMMARY OF THE DISCLOSURE

In an aspect of the disclosure, a runout calibrator adapted for use in a machine tool having a spindle with a chuck that rotates includes a shaft adapted at a first end for mounting in the chuck, the shaft having a centerline at a longitudinal axis of rotation, and a head mounted to a second end of the shaft. The head has at least one line of symmetry that is coincident with the centerline of the shaft. The head also has a reflective surface. The runout calibrator includes a sensor assembly with at least one sensor, the at least one sensor having light source and a light detector. The sensor assembly can be mounted to measure a distance between the at least one sensor and the reflective surface of the head.

In another aspect of the disclosure, a method of testing runout in a machine tool having a spindle with a chuck where the spindle is coupled to the machine tool via a hydrodynamic bearing includes mounting a head assembly into the chuck and disposing a sensor assembly proximate the head assembly, the sensor assembly has one or more sensors that measure a distance to a remote object. The head assembly can include a shaft having a centerline at a longitudinal axis of rotation and has a first end and a second end with the first end adapted for mounting in the chuck. The head assembly also includes a head mounted to the second end of the shaft, the head having at least one line of symmetry coincident with the centerline of the shaft. The head also has a reflective surface. The method continues with activating the machine tool to rotate the spindle and the head assembly at an operating speed, the operating speed being a rotational speed of the spindle at which the machine tool is operated for beneficial use. After the spindle and the head assembly reaches the operating speed, the method may continue by sampling a plurality of distances between each of the one or more sensors in the sensor assembly and the head and for each of the one or more sensors, calculating a difference between a maximum distance and a minimum distance of the plurality of distances to develop a runout value for the head at each sensor of the one or more sensors. The method may continue by determining when any the runout value for any of the one or more sensors exceeds a predetermined limit to indicate that the machine tool requires maintenance.

In yet another aspect of the disclosure, a runout calibrator for use in measuring runout of a spindle of a machine tool using at least one hydrodynamic bearing includes a head assembly with a shaft adapted at a first end for mounting in a chuck of the machine tool, the shaft having a centerline at a longitudinal axis of rotation and a head mounted to a second end of the shaft, the head having at least one line of symmetry coincident with the centerline of the shaft and a reflective surface disposed on all exposed areas of the head. The runout calibrator may also include a sensor assembly including three optical sensors mounted orthogonal to each other.

These and other aspects and features will be more readily understood when reading the following detailed description when taken in conjunction with the accompanying drawings.

### BRIEF DESCRIPTION OF THE DRAWINGS

FIG. 1 is a schematic illustration of a machine tool employing the teachings of the present disclosure;

FIG. 2 is a schematic illustration of runout in the machine tool of FIG. 1;

FIG. 3 is a schematic illustration of droop in an inactive hydrodynamic bearing;

FIG. 4 is a perspective view of a runout calibrator in accordance with the disclosure;

FIG. 5 is a perspective view of yet another embodiment of a runout calibrator;

FIG. 6 is a perspective view of still another embodiment of a runout calibrator;

FIG. 7 is a block diagram of an optical sensor; and

FIG. 8 is a flowchart of an exemplary method of testing runout in a machine tool that uses hydrodynamic bearings.

### DETAILED DESCRIPTION

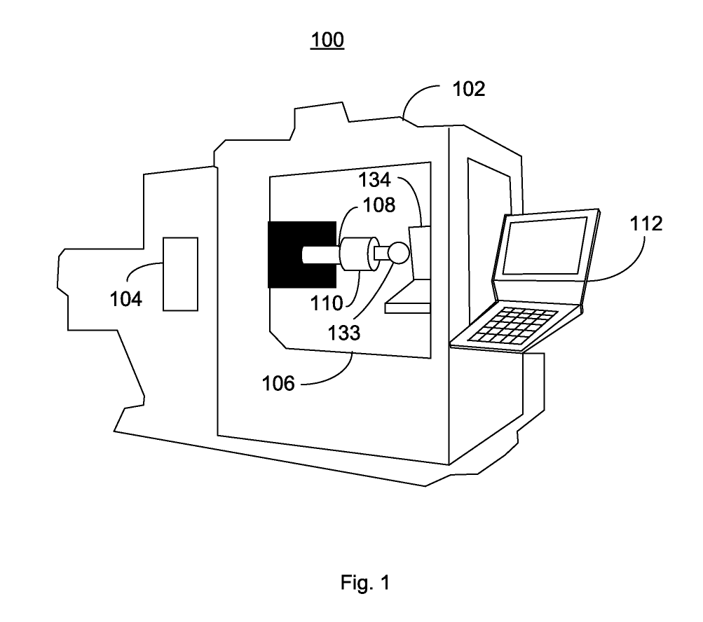

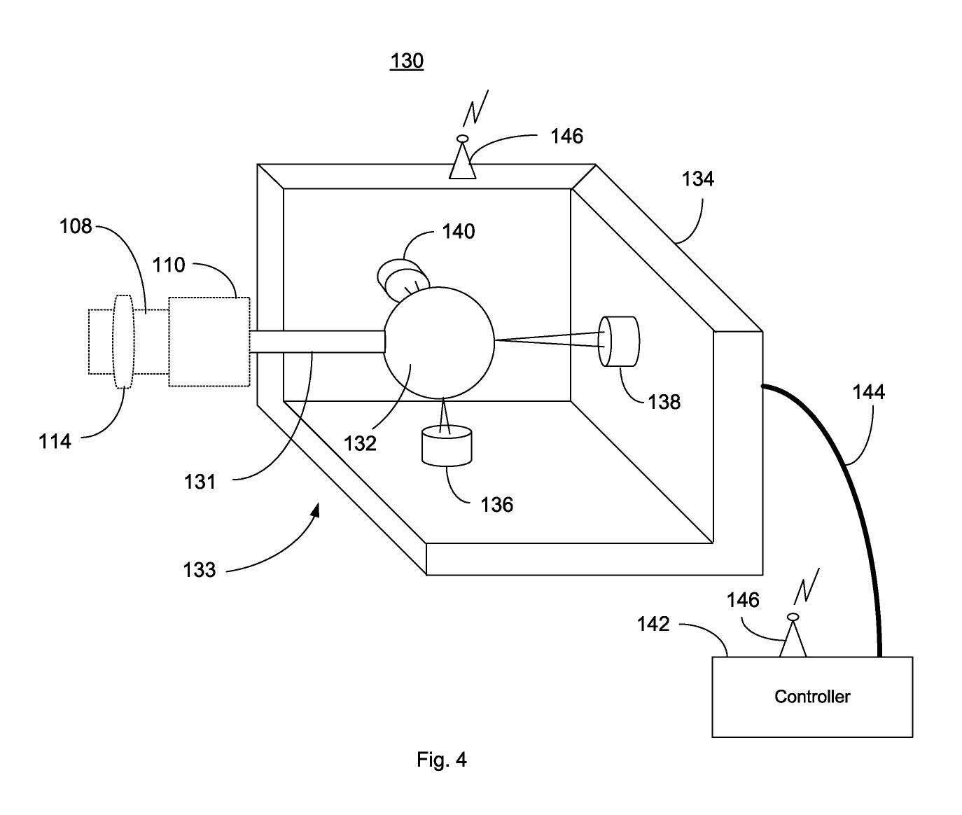

Referring now to the drawings, and with specific reference to FIG. 1 a machine tool 100 that can be used in a number of industries to produce precision parts by milling, drilling, or the use of other material removal techniques is discussed. The machine tool 100 may include a cabinet 102 and a motor 104. A work space may include a failsafe cover 106 that prevents the motor 104 from running when the cover 106 is open. Inside the workspace, a spindle 108 may be coupled to the motor 104. The spindle 108 may include a chuck 110 which is used to grasp a particular work tool (not depicted). A computer 112 or other controller may be used to programmably guide the spindle 108 and therefore the work tool so that a particular end product may be created in the machine tool 100. A head assembly 133 and sensor assembly 134, discussed in more detail below with respect to FIGS. 4-6 may be incorporated into the machine tool 100.

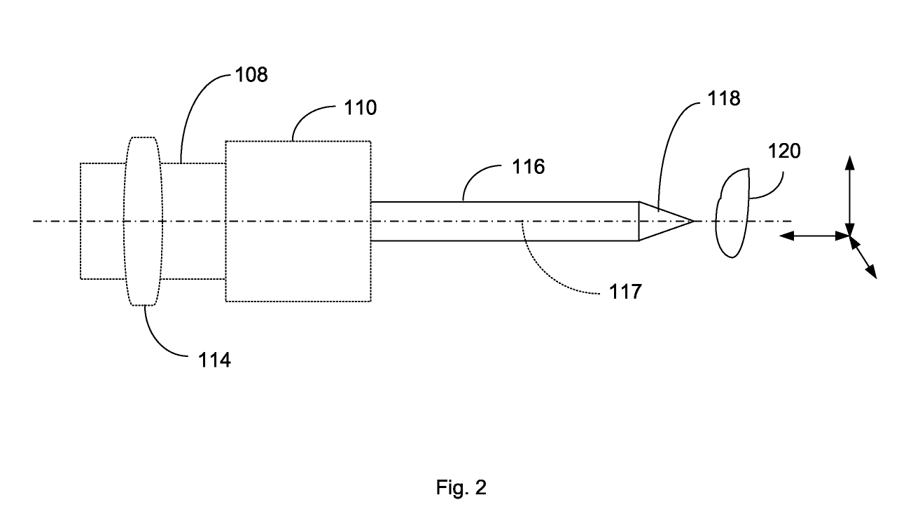

FIG. 2 is an illustration of spindle-related components of the machine tool 100. A spindle 108 may be coupled to a chuck 110 which holds a tool 116 with a representative work tip 118. The spindle 108 is supported by a bearing, in this example, a hydrodynamic bearing 114. Other bearings may also be used to support the spindle 108. Runout is a measurement of how accurately a tool, such as tool 116, stays on center as the spindle 108 is rotated about a longitudinal axis of rotation 117. The ability of the tool to stay on center during operation is perhaps the most significant component of its ability to accurately reproduce a desired part.

A representative runout map 120 for the spindle 108 illustrates that the work tip 118 moves significantly off-center as the spindle 108 is rotated. Runout has components in three dimensions, that is, both vertically and horizontally as well as axially and is almost exclusively influenced by the bearing 114 and any other support bearings or end bearings holding the spindle 108. As discussed above, hydrostatic bearings using a pressurized oil source, or ball bearings are active at all times and runout can be measured simply by low-speed rotation of the spindle.

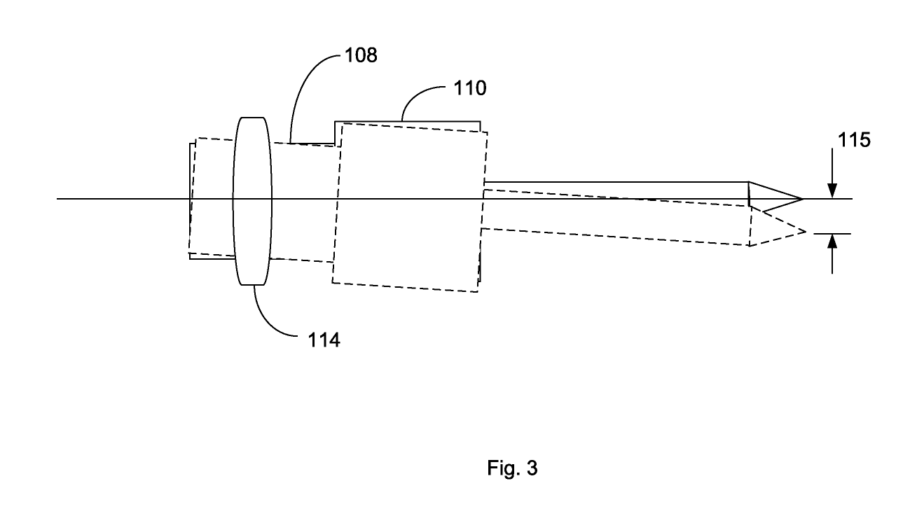

When a bearing is a hydrodynamic bearing 114, the spindle 108 will droop considerably when the spindle 108 is at rest. As shown in FIG. 3, this is due to the hydrodynamic bearing 114 not having any oil pressure provided by the actual motion of the spindle 108. The at-rest spindle 108 is depicted by dashed lines while the spindle 108 operating at speed with the hydrodynamic bearing 114 fully active is shown in solid lines. A droop 115 may be several millimeters which is well beyond required tolerance of 100 μm required for mounting a ceramic-type runout sensor.

Referring now to FIG. 4, a runout calibrator 130 constructed in accordance with the present disclosure is depicted. As shown, the runout calibrator 130 may include a shaft 131 and a head 132 mounted to the chuck 110 as supported by the spindle 108 and hydrodynamic bearing 114. The shaft 131 and head 132 may be assembled into a head assembly 133. A sensor assembly 134 may be placed proximate to the head 132 and may include optical sensors 136, 138, 140, disposed in three orthogonal axes. The sensor 136 may measure vertical deflection of the head 132, the sensor 138 may measure axial deflection of the head 132, and the sensor 140 may measure horizontal deflection of the head 132. The sensors 136, 138, 140, may include a laser source and an optical sensor that allows measurement accuracy of one micron or less while operating at a distance of a centimeter or more.

Because the sensors 136, 138, 140, can be located so far from the head 132, there is no difficulty in positioning the sensor assembly 134 proximate the head 132 while the machine tool 100 is still at rest. After the spindle reaches an operating speed, in many cases 30,000 RPMs or more, the spindle 108 will come back on center and the runout measurement may be safely taken.

A controller 142 may be coupled to each of the sensors 136, 138, 140 via a cable 144 or a wireless network 146 that carry a signal with distance information from each sensor 136, 138, 140. Using either communication type, the sensor assembly 134 may be safely placed while the machine tool 100 is at rest and all the interlocks kept fully functional during the runout testing process. That is, the cable 144 may be brought out along a seal in cover 106 or the measurement data may be transmitted wirelessly using the wireless network 146 so that the cover 106 may remain in place and operator safety is not compromised during the test.

The head 132 may be a sphere covered with a reflective surface. Spheres with an accuracy of 10-20 nanometers are commercially available from a number of suppliers. Because the head 132 is so highly symmetric, the difference between a maximum distance measurement for any individual sensor 136 and a minimum distance measurement for the same sensor 136 can be attributed solely to runout of the spindle 108. To ensure that sufficient light is reflected from the head 132 back to any respective sensor 136, 138, or 140, the head 132 may be made from a reflective surface. These surfaces may include a precision honed or lapped carbide ball or an Inconel ball. Other surface finishes may include polished stainless steel or plated with chrome, silver, gold or another reflective coating. In some embodiments, it may be desirable for the head 132 to be corrosion resistant, for example, when corrosive substances may be used in the machining process.

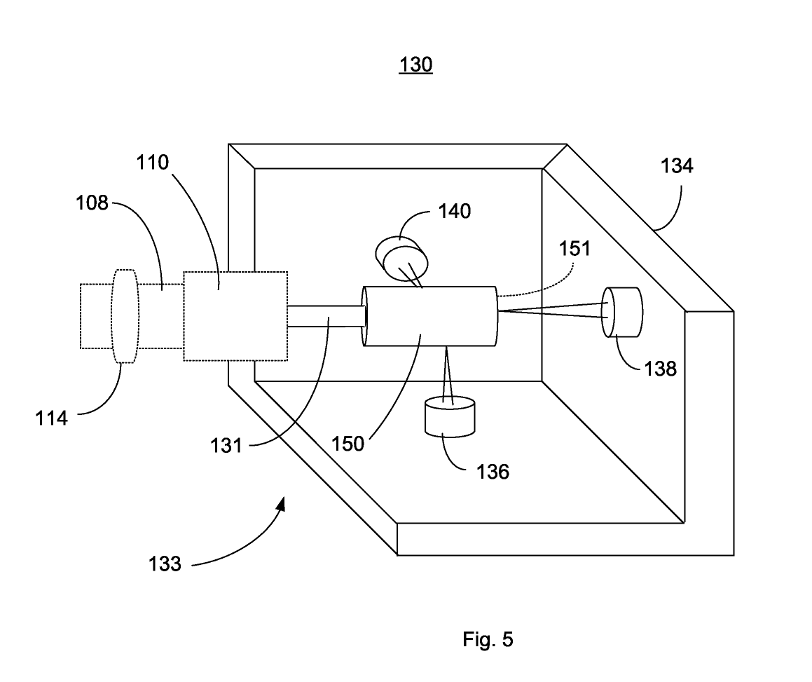

Another embodiment of the head assembly 133 is depicted in FIG. 5, where the head 150 is a cylinder with both a reflective side and flat, reflective top face 151. The cylindrical head 150 may be easier to manufacture and mount on the shaft 131 than the sphere-shaped head 132 of FIG. 4.

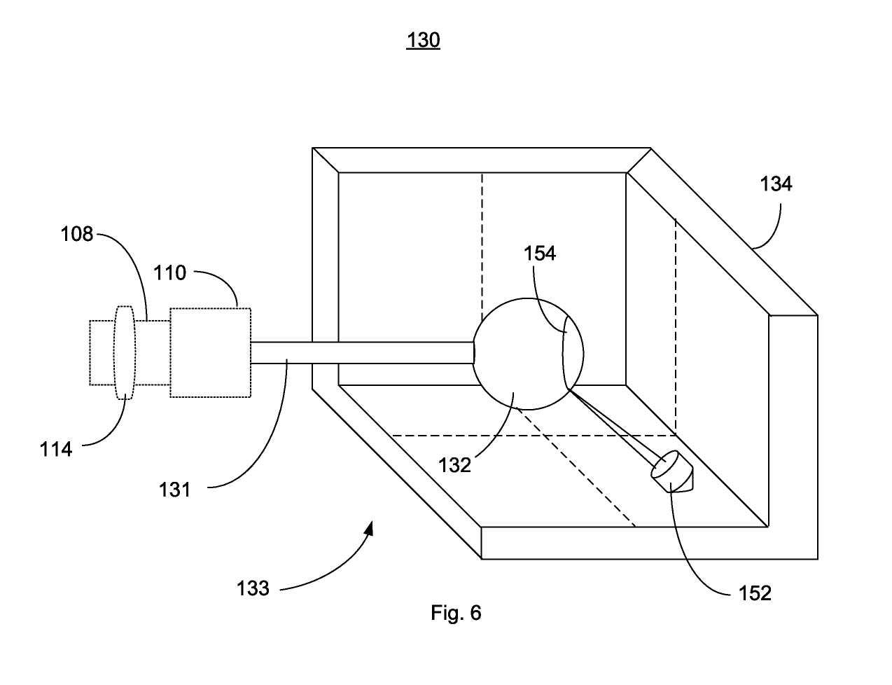

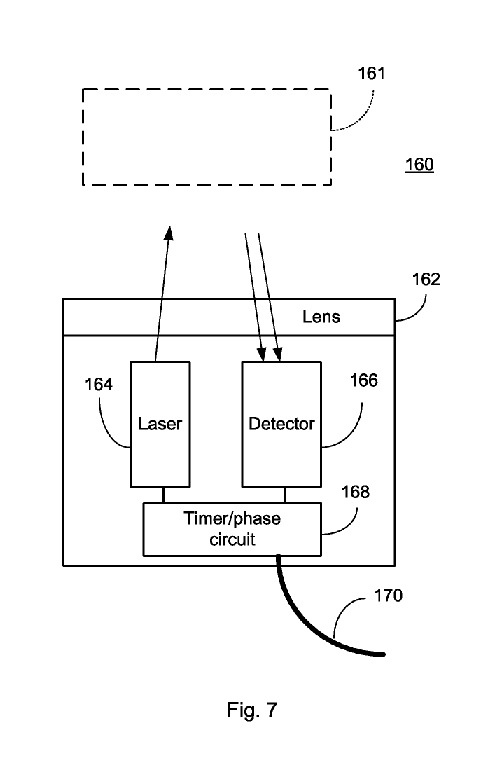

Yet another embodiment of the runout calibrator 130 is set forth in FIG. 6 and which uses a spherical head 132 that, in this embodiment, has only a single sensor 152 placed at an oblique angle with respect to the head 132. That is, the sensor 152 is not on any of the horizontal, vertical, or axial coordinates. A reference line 154 illustrates a circle traced on the surface of the head 132 by the light source of the sensor 152. Deflection of the shaft 131 in any direction will cause a change in the distance between the sensor 152 and head 132 that can be used to determine a runout error. While the configuration illustrated in FIG. 7 cannot be used to indicate in which axis runout is most significant, it can be used as a pass/fail indication of runout. In an embodiment, for certain machine tools 100 a runout test fails when runout in any dimension is greater than several microns and particularly more than 5-10 microns.

FIG. 7 illustrates a representative sensor 160 suitable for use in the above-discussed embodiments of the runout calibrator 130. The sensor 160 may include a lens to pass light, a light source 164, such as a laser, and a detector 166. A timer/phase circuit 168 may measure either the time delay or phase shift of light output from the laser 164 that is received at the detector 166 to determine a distance between the sensor 160 and a remote object 161 from which light from the laser 164 is reflected. Data output from the sensor 160 and control signals to the sensor 160 may be passed via connection 170 to a controller 142. Such sensors are commercially available off-the-shelf parts. In an embodiment, one or more sensors 160 may be incorporated into the construction of the machine tool 100, for example, in a shielded area of the workspace. In another embodiment, various embodiments of the head assembly 133 may be mounted in or on the machine tool 100. To the extent some variations in head assembly 133 and sensor assembly 134, sensor brightness, or other variables influence the applicable design of the runout calibrator 130, the machine tool 100 may have a runout calibrator 130 incorporated in the machine tool 100 itself.

### INDUSTRIAL APPLICABILITY

In general, the present disclosure can find industrial applicability in a number of different settings. For example, the present disclosure may be employed in manufacturing tools used to make parts for a variety of machines, such as but not limited to, engines, transmissions and actuators. Such machines may be employed in many different end products, such as, but not limited to those used in the earth-moving, construction, mining, agriculture, transportation, and marine industries.

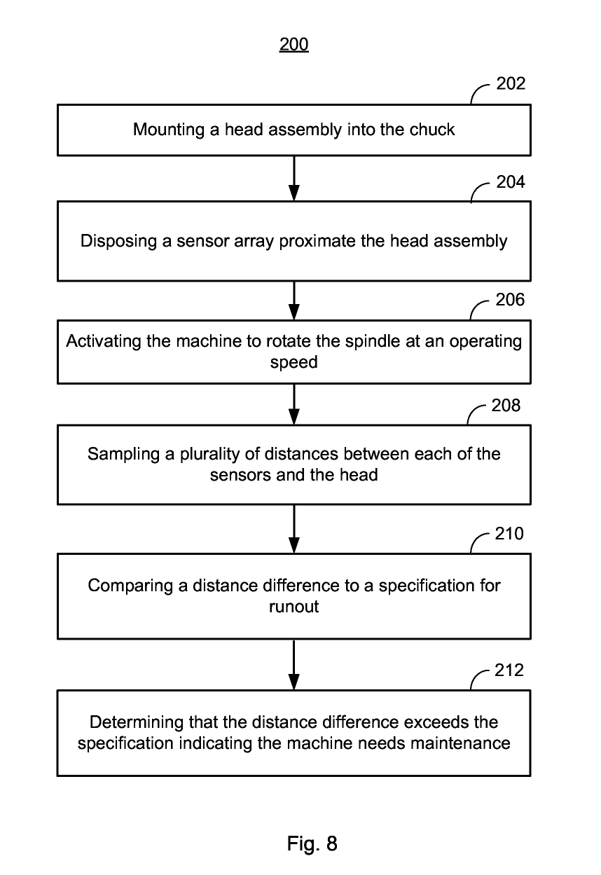

FIG. 8 is a flowchart of a method 200 of testing runout in a machine tool 100. The machine tool 100 may have a spindle 108 with a chuck 110, the spindle 108 coupled to the machine tool 100 via a hydrodynamic bearing 114. At block 202, a head assembly 133 may be mounted into the chuck 110. The head assembly 133 may include a shaft 131 having a first end adapted for mounting in the chuck 110. The shaft 131 may have a centerline of a longitudinal axis of rotation of the spindle 108. The head assembly 133 may also include a head 132 mounted to a second end of the shaft 131. The head 132 may also have at least one line of symmetry coincident with the centerline of the shaft 131. For example, the head 132 may be a sphere, a cylinder, or a another symmetric shape, among others. The head 132 may have a reflective surface. In various embodiments, the head 132 may be made from a polished stainless steel or may be plated with chrome, gold, silver, or another highly reflective surface.

At block 204, a sensor assembly 134 may be disposed proximate the head assembly 133. The sensor assembly 134 may include three sensors 136, 138, 140, arranged on orthogonal axes. In other embodiments, the sensor assembly 134 may include more or fewer than three sensors, for example in the embodiment shown in FIG. 4 sensor assembly 134 has only one sensor 152. Each sensor 162 of the sensor assembly 134 includes a laser source 164 and a light receptor or light detector 166. In an embodiment, the sensor assembly 134 may be placed so that each sensor 136, 138, 140 is, in some embodiments, 5 millimeters from the head 132. In other embodiments, the head 132 may be as much as 1 centimeter from the sensors 136, 138, 140 when the machine tool 100 is not operating.

The machine tool 100 may be activated to rotate the spindle 108 and the head assembly 133 at an operating speed as shown at block 206. In an embodiment, the operating speed may be that at which the machine tool 100 is operated for beneficial use, that is, a speed typical during machining operations. For some machine tools 100 this speed may be 30,000 revolutions per minute or more.

At block 208, after the spindle 108 and the head assembly 133 reaches its operating speed, a plurality of distances may be sampled between one or more sensors 136, 138, 140 in the sensor assembly 134 and the head 132. That is, each sensor 136, 138, 140 may separately report a continuous measurement of distance between that individual sensor and the head 132. The controller 142 may log these distances as they are reported.

For each sensor 136, 138, 140 a maximum distance between each individual sensor and the head 132 may be identified along with a minimum distance between each individual sensor and the head 132 as shown shown at block 210. The difference between the maximum distance in the minimum distance is the runout value. These individual runout values may be compared to a specified maximum allowable runout value for the particular machine tool 100. In other embodiments, the sensors 136, 138, 140 may internally calculate a running difference between a maximum and minimum measurement for that sensor.

At block 212, each calculated runout value may be compared to a predetermined limit for runout value to determine that the machine tool 100 requires maintenance due to excessive runout. In an embodiment, the controller 142 may post a message or turn on alarm as an indicator that the runout test has failed.

Use of the apparatus and method discussed above for determining runout in a machine tool 100 using hydrodynamic bearings 114 is a significant advantage to machine tool 100 operators in that runout calibration can now be performed quickly and safely at high operating speeds. Using this diagnostic capability significantly reduces the chance of creating parts that fail to meet their tolerance specifications. Beyond that, this testing allows early diagnosis of bearing 114 problems before the bearing degenerates to a point that a very costly spindle failure occurs.

What is claimed is:

1. A runout calibrator adapted for use in a machine tool having a spindle with a chuck that rotates, the runout calibrator comprising:
a shaft having a first end adapted for mounting in the chuck, the shaft having a centerline at a longitudinal axis of rotation;
a head mounted to a second end of the shaft, the head having at least one line of symmetry coincident with the centerline of the shaft and a reflective surface; and
a sensor assembly including at least one sensor, the at least one sensor having light source and a light detector, the sensor assembly mounted to measure a distance between the at least one sensor and the reflective surface of the head.

2. The runout calibrator of claim 1, further comprising a controller coupled to the at least one sensor that compares a measured runout based on variations of the distance from the at least one sensor to the reflective surface of the head with a specified maximum runout.

3. The runout calibrator of claim 1, wherein the controller is coupled to the at least one sensor using a wireless network.

4. The runout calibrator of claim 1, wherein the reflective surface is one of gold, silver, chrome, lapped carbide, honed carbide, Inconel, or polished stainless steel.

5. The runout calibrator of claim 1, wherein the sensor assembly comprises three sensors mounted orthogonal to each other.

6. The runout calibrator of claim 1, wherein the head is a sphere.

7. The runout calibrator of claim 1, wherein the head is a cylinder with a flat, reflective top face.

8. The runout calibrator of claim 1, wherein the head is balanced and symmetric for rotation at 25,000 rpm or higher.

9. The runout calibrator of claim 1, wherein the head is corrosion resistant.

10. The runout calibrator of claim 1, wherein the shaft is a cylinder.

11. A method of testing runout in a machine tool having a spindle with a chuck, the spindle coupled to the machine tool via a hydrodynamic bearing, the method comprising:
mounting a head assembly into the chuck, the head assembly including a shaft having a first end and a second end, the first end adapted for mounting in the chuck, the shaft having a centerline at a longitudinal axis of rotation and a head mounted to the second end of the shaft, the head having at least one line of symmetry coincident with the centerline of the shaft and a reflective surface;
disposing a sensor assembly proximate the head assembly, the sensor assembly including one or more sensors that measure a distance to a remote object;
activating the machine tool to rotate the spindle and the head assembly at an operating speed, the operating speed being that at which the machine tool is operated for beneficial use;
after the spindle and the head assembly reaches the operating speed, sampling a plurality of distances between each of the one or more sensors in the sensor assembly and the head;
for each of the one or more sensors, calculating a difference between a maximum distance and a minimum distance of the plurality of distances to develop a runout value of the head for each sensor of the one or more sensors; and
determining when any the runout value for the head at any of the one or more sensors exceeds a predetermined limit to indicate that the machine tool requires maintenance.

12. The method of claim 11, wherein the sensor assembly includes three sensors arranged on orthogonal axes.

13. The method of claim 12, wherein each of the one or more sensors of the sensor assembly includes a laser source and a light detector.

14. The method of claim 13, wherein disposing the sensor assembly proximate the head assembly comprises disposing the sensor assembly so that each of the one or more sensors is farther than 5 millimeters from the head when the machine tool is not operating.

15. The method of claim 11, wherein calculating the difference between the maximum distance and the minimum distance of the plurality of distances to develop the runout value for the head at each of the one or more sensors comprises calculating the difference at a controller.

16. The method of claim 11, wherein the head having at least one line of symmetry has a shape that is selected from a sphere or a cylinder.

17. A runout calibrator for use in measuring runout of a spindle of a machine tool using at least one hydrodynamic bearing, comprising:
a head assembly including:
a shaft having a first end adapted for mounting in a chuck of the machine tool, the shaft having a centerline at a longitudinal axis of rotation; and
a head mounted to a second end of the shaft, the head having at least one line of symmetry coincident with the centerline of the shaft and a reflective surface disposed on all exposed areas of the head; and
a sensor assembly including three optical sensors mounted orthogonal to each other.

18. The runout calibrator of claim 17, wherein the reflective surface of the head is one of a plated chrome finish, a plated gold finish, and a polished stainless steel finish.

19. The runout calibrator of claim 17, further comprising a controller that receives signals from each of the three optical sensors and calculates a runout value based on a variation in distance of the head from each of the three optical sensors as the head rotates at an operating speed.

20. The runout calibrator of claim 19, wherein the sensor assembly further comprises one of a cable and a wireless network to carry a signal with distance data from each of the three optical sensors to the controller.
